(19) United States
(12) Patent Application Publication
(10) Pub. No.: US 2021/0325088 A1
(43) Pub. Date: Oct. 21, 2021

(54) HEAT TRANSFER DEVICE

(71) Applicant: Stellenbosch University, Stellenbosch (ZA)

(72) Inventors: Derwalt Johannes ERASMUS, Cape Town (ZA); Theodor Willem VON BACKSTRÖM, Stellenbosch (ZA); David MCDOUGALL, Pretoria (ZA); Matti LUBKOLL, Offenhausen (DE)

(73) Assignee: Stellenbosch University, Stellenbosch (ZA)

(21) Appl. No.: 17/312,583

(22) PCT Filed: Dec. 11, 2019
(86) PCT No.: PCT/IB2019/060650

§ 371 Date: Jun. 10, 2021

(30) Foreign Application Priority Data
Dec. 11, 2018 (ZA) 2018/08340

(51) Int. Cl. F24S 20/20; F28D 7/12; F28F 13/06; F24S 23/71; F24S 70/60

(52) U.S. Cl. CPC F24S 20/20; F28D 7/12; F28D 2021/0029; F24S 23/71; F24S 70/60; F28F 13/06

(57) ABSTRACT

A heat transfer device (100) includes an inner tube (102) mounted within a tubular chamber (104) of a heat exchanger (106). The hollow tubular chamber (104) has a closed end (108) with inwardly sloping inner surfaces (110) and the inner tube (102) has an open end (112) that terminates short of the closed end (108). A diffuser (114) is provided and is shaped such that an operatively front part (116) thereof substantially conforms to a shape of the inner surfaces (110) of the closed end (108) so as to form a narrow flow passageway (118) between the diffuser (114) and the inner surfaces (110) at the closed end (108), and an operatively back part (120) of the diffuser (114) slopes towards the inner tube (102) and away from its open end (112) to form a diffusion zone (122). Heat transfer assemblies utilising the heat transfer device (100) are also disclosed.

### CROSS-REFERENCE TO RELATED APPLICATIONS

This application claims priority from South African provisional patent application number 2018/08340 filed on 11 Dec. 2018, which is incorporated by reference herein.

### FIELD OF THE INVENTION

This invention relates to a heat transfer device in which a working fluid impinges onto a surface so as to transfer heat between the working fluid and the surface.

### BACKGROUND TO THE INVENTION

Impingement heat transfer assemblies find particular, but by no means exclusive, application in the field of solar thermal energy systems in which a central receiver is heated by reflected sunlight from multiple tracking mirrors called heliostats. A working fluid is directed through a pipe to impinge onto a heat exchanger and become heated thereby. The working fluid can be transported to a turbine where electricity is generated or can be used to heat a secondary fluid to be transported to a turbine.

One such impingement heat transfer assembly is disclosed in the applicant's U.S. Pat. No. 9,964,335, in which an inlet chamber and outlet chamber are connected to each other by way of a multitude of tube assemblies each of which has an inner tube and an outer tube. A remote end of each outer tube is closed and a passageway is formed to connect the inlet and outlet chambers by way of the interior of the inner tube and a space between the inner and outer tubes. Pressurized working fluid exits the inner tube and impinges on an inner, domed-shaped surface of the closed outer tube, and then changes its direction of flow by 180° to travel in the space between the inner and outer tubes.

In heat transfer assemblies, mechanical energy of the working fluid is dissipated through phenomena such as friction and through viscous heating, which occurs during rapid expansion of the working fluid. The amount of energy required to move the working fluid through the heat transfer assembly is directly related to the decrease in total pressure of the working fluid across the heat transfer assembly. It is therefore desirable for the drop in total pressure of the working fluid across the heat transfer assembly to be as low as possible. It is also desirable for the heat transfer coefficient of a heat transfer assembly to be maximised. However, an increase in the heat transfer coefficient usually results in an increase in the total pressure drop within the system.

The applicant has found that in existing impingement heat transfer assemblies, the working fluid may undergo rapid expansion around the region of impingement, resulting in mechanical energy being dissipated in the form of heat and a resultant drop in total pressure.

European patent publication EP2520872 and the publication of Garbrecht, A-Sibai, Kneer, & Wighardt, CFD-simulation of a new receiver design for a molten salt solar power tower, Solar Energy 90, pp 94-106 (2013), disclose a heat collection arrangement that has multiple hexagonal pyramidal elements carried by a common chamber wall. Heat transfer fluid in the form of molten salt is introduced to the apex of each of the pyramidal elements and become heated by solar energy as it flows through finned channels between the outer wall of the pyramidal element that become heated by solar energy and an inner pyramidal wall spaced inwardly of the outer wall. The concept is to trap solar energy between the converging outer walls of adjacent pyramids. This arrangement, however, still results in rapid expansion in the area of convergence which results in mechanical energy being dissipated. It may also contain hotspots caused by a non-uniform fluid velocity distribution within the finned channels.

There is accordingly scope for improvement.

The preceding discussion of the background to the invention is intended only to facilitate an understanding of the present invention. It should be appreciated that the discussion is not an acknowledgment or admission that any of the material referred to was part of the common general knowledge in the art as at the priority date of the application.

### SUMMARY OF THE INVENTION

There is provided a heat transfer device comprising an inner tube mounted within a hollow tubular chamber of a heat exchanger, the hollow tubular chamber having a closed end that has concave or inwardly sloping inner surfaces and the inner tube having an open end that terminates short of the closed end of the tubular chamber, characterized in that a diffuser is provided around a section of the inner tube adjacent its open end, the diffuser being shaped such that an operatively front part of the diffuser substantially conforms to the shape of the inner surfaces of the closed end of the hollow tubular chamber so as to form a narrow flow passageway between the diffuser and the inner surfaces at the closed end, and an operatively back part of the diffuser slopes or transitions towards the inner tube and away from its open end to form a diffusion zone in the hollow tubular chamber, wherein a working fluid moves through the inner tube to exit its open end, impinges on the closed end of the tubular chamber, is directed through the narrow flow passageway and undergoes pressure recovery in the diffusion zone.

The diffuser may have a bulbous shape in cross section along an axis of the inner tube, with a bulb portion of the bulbous shape conforming to the inner surfaces of the closed end of the heat exchanger's tubular chamber. The bulbous shape may be a tear-drop shape. The narrow flow passageway may then be an annular channel.

The closed end of the tubular chamber may be concave; in one embodiment hemispherical. The heat exchanger may be in the form of an outer tube with a closed end. The heat exchanger may be a heat absorber.

The inner tube may have a nozzle at its open end that reduces a width of the inner tube to accelerate the working fluid exiting the open end. In one embodiment, the nozzle is integral with the diffuser and is formed by a projecting inner portion of the diffuser.

The diffuser may be made from a material capable of resisting high temperatures, in one embodiment a nickel-based alloy; it may be made as a solid part; and it may include an attachment formation by which it can be attached to the inner tube or to inner surfaces of the closed end of the hollow tubular chamber.

The heat transfer device may be an impingement heat transfer device. The working fluid may be air, water, steam, carbon dioxide or molten salt; and the working fluid may be pressurized.

There is also provided a heat transfer assembly in which at least one heat transfer device as described is arranged with the closed ends of the (or each) heat transfer device directed to receive reflected solar radiation so that maximum heating occurs at the closed ends.

A plurality of heat transfer devices may be clustered together, preferably in a tessellated manner, to form the heat transfer assembly. The heat transfer assembly may be part of a central receiver of a solar thermal energy system. The heat transfer assembly may have an inlet chamber and an outlet chamber which are connected to each other by way of the plurality of heat transfer devices such that the inlet chamber communicates with the inner tubes and the outlet chamber communicates with a space external of the inner tubes and within the hollow tubular chambers of the heat exchangers.

The heat transfer assembly may include a dish structure surrounding the plurality of heat transfer devices, or spaced apart from them, in either case for reflecting sunlight focused on the dish structure onto the heat transfer devices.

Alternatively, a heat transfer assembly with one heat transfer device may be provided, in which case the heat transfer device may be mounted within a cavity formed by a receiver body, the receiver body being shaped with differently angled internal walls so that incoming solar radiation enters through an aperture in the receiver body, is substantially trapped and is reflected within the cavity to be directed onto the heat transfer device, and in which the heat transfer assembly includes a dish structure spaced apart from the receiver body for reflecting sunlight focused on the dish structure into the aperture.

Embodiments will now be described, by way of example only, with reference to the accompanying drawings.

### BRIEF DESCRIPTION OF THE DRAWINGS

In the drawings:

FIG. 1 is a part sectioned schematic view of a heat transfer assembly in the form of a central solar receiver with a plurality of heat transfer devices;

FIG. 2 is a part sectioned view of one heat transfer device;

FIG. 3 is a cross sectional view of the heat transfer device of FIG. 2;

FIG. 4 is a schematic illustration similar to FIG. 3 but showing working fluid dynamic pressure;

FIG. 5 is a Computational Fluid Dynamics (CFD) simulation showing total pressure contoured path lines in a reference heat transfer device not according to the invention;

FIG. 6 is similar to FIG. 5 but showing the total pressure contoured path lines of the heat transfer device of a described embodiment;

FIG. 7 is a schematic sectional view of an experimental setup;

FIG. 8 is similar to FIG. 3 and shows the physical dimensions of one prototype used in the experimental setup;

FIG. 9 is a graph showing the heat transfer coefficients of two prototypes in comparison with two references, as a function of mass flow rate;

FIG. 10 is a graph showing total pressure loss of the two prototypes in comparison with two references, as function of mass flow rate;

FIG. 11 is a high-temperature computational fluid dynamics (CFD) graph showing heat transfer coefficients of two prototypes compared with those references, as a function of mass flow rate;

FIG. 12 is a high-temperature CFD graph showing total pressure loss of the two prototypes of FIG. 11 in comparison with the two references of FIG. 11, as a function of mass flow rate;

FIGS. 13A to 13F show an alternative embodiment of a heat transfer device and an associated heat transfer assembly;

FIGS. 14A to 14H show a further alternative embodiment of a heat transfer device and an associated heat transfer assembly;

FIGS. 15A to 15F show a yet further alternative embodiment of a heat transfer device and an associated heat transfer assembly;

FIG. 16A is a cross sectional view of a still further alternative embodiment of a heat transfer device;

FIG. 16B is a detail view of a portion “A” of FIG. 16A;

FIG. 17A is an elevated view of an alternative heat transfer assembly in the form of a central solar receiver with a plurality of impingement heat transfer devices;

FIG. 17B is a cross-sectional view along line “A-A” in FIG. 17A;

FIG. 18A is a cross-sectional elevation of a further alternative heat transfer assembly in the form of a central solar receiver with a single impingement heat transfer device; and

FIG. 18B is a detail view of the receiver portion of the heat transfer assembly.

### DETAILED DESCRIPTION WITH REFERENCE TO THE DRAWINGS

Embodiments of this disclosure provide a heat transfer device. The heat transfer device may include an inner tube mounted within a hollow tubular chamber. The hollow tubular chamber may be part of, or may be connected to, a heat exchanger. The hollow tubular chamber may have a closed end that has concave or inwardly sloping inner surfaces, and the inner tube may have an open end that terminates short of the closed end of the tubular chamber. In described embodiments, a diffuser is provided around a section of the inner tube. The diffuser may be provided around a section of the inner tube adjacent its open end. The diffuser may be shaped such that an operatively front part of the diffuser substantially conforms to the shape of the inner surfaces of the closed end of the hollow tubular chamber so as to form a narrow flow passageway between the diffuser and the inner surfaces at the closed end. The diffuser may also be shaped such that an operatively back part of the diffuser slopes or transitions towards the inner tube and away from its open end to form a diffusion zone in the hollow tubular chamber. In use, a working fluid may move though the inner tube to exit its open end, impinge on the closed end of the tubular chamber, be directed through the narrow flow passageway and be diffused in the diffusion zone.

Embodiments of the disclosure also provide a heat transfer assembly that includes a plurality of heat transfer devices. The heat transfer devices may be clustered together, in some embodiments in a tessellated manner. The heat transfer assembly may be part of a central receiver of a solar thermal energy system.

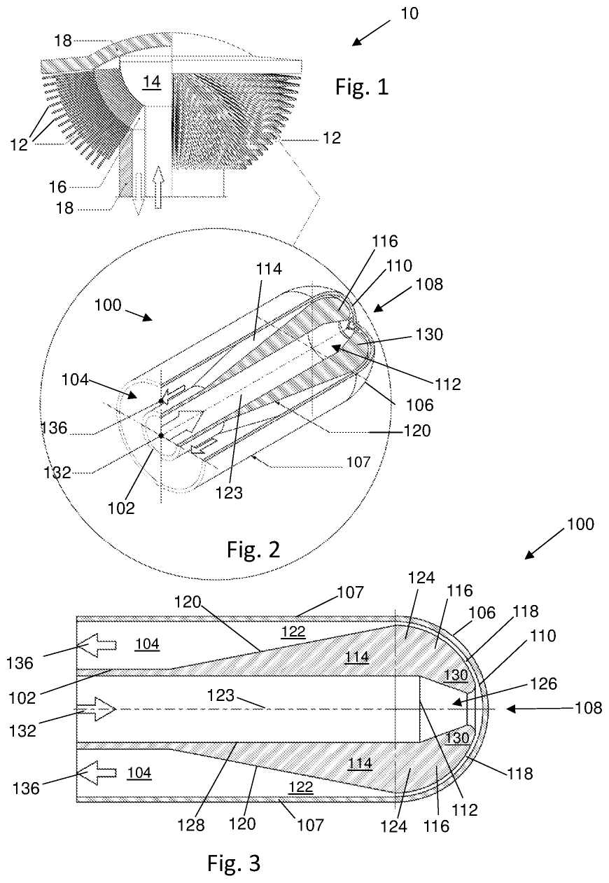

FIG. 1 shows an exemplary heat transfer assembly (10), which in this illustration is a central receiver of a solar thermal energy system. The heat transfer assembly (10) includes a plurality of heat transfer devices (12). In this example, the heat transfer assembly (10) has an inlet chamber (14) and a concentric juxtaposed outlet chamber (16) and the two chambers are connected to each other through the plurality of heat transfer devices (12). An insulation layer (18) may cover portions of the central solar receiver (10) to preserve thermal energy therein. Each heat transfer device (12) may be elongated and extend in a direction from which solar radiation will be received. Concentrated solar radiation may be applied from multiple tracking mirrors called heliostats, in one example, in which case the heat transfer assembly is a central solar receiver which may be mounted atop a tower or other structure.

FIGS. 2 and 3 show detailed views of an exemplary heat transfer device (100), which may be an embodiment of one of the plurality of heat transfer devices (12) of FIG. 1. In this example, the heat transfer device (100) is an impingement heat transfer device. The heat transfer device (100) includes an inner tube (102) mounted within a hollow tubular chamber (104) of a heat exchanger (106). In this embodiment the heat exchanger (106) is formed as an outer tube (107) with a closed end (108), and functions as a heat absorber, but in other embodiments the heat exchanger could function as a heat emitter. The closed end (108) of the outer tube (107) has concave inner surfaces (110), in this embodiment a hemispherical surface. Other concave shaped or inwardly sloping inner surfaces could also be used as will become apparent from the further embodiments disclosed herein.

The inner tube (102) has an open end (112) that terminates short of the closed end (108) of the hollow tubular chamber (104), and a section of the inner tube (102) adjacent its open end (112) includes a diffuser (114) provided around that section. The diffuser (114) is shaped such that an operatively front part (116) thereof substantially conforms to the shape of the inner surfaces (110) of the closed end (108) of the hollow tubular chamber (104) so as to form a narrow flow passageway (118) between the diffuser (114) and the inner surfaces (110) at the closed end (108), which in this embodiment is between two hemispherical surfaces. An operatively back part (120) of the diffuser slopes or transitions gradually towards the inner tube (102) and away from its open end (112) to form a diffusion zone (122) in the hollow tubular chamber (104). In this embodiment, the operatively back part (120) of the diffuser slopes along a straight line, but the operatively back part (120) may slope or transition away from the operatively front part (116) towards the inner tube (103) along a different curve, such as a parabolic curve.

It will be apparent from what follows that the diffuser (114) functions to affect pressure recovery in the diffusion zone (122) at the operatively back part (120) thereof, whereas the operatively front part (116) may function primarily as a flow enhancement and heat transfer enhancement part. For the sake of brevity, the entire structure is referred to as the “diffuser (114)” despite the fact that the front part (116) thereof has other functions. The narrow flow passageway (118) can act as a combination of a nozzle and a diffuser.

The diffuser (114) may have a bulbous shape in cross section along an axis (123) of the inner tube (102), as most clearly shown in FIG. 3, with a bulb (124) portion of the bulbous shape conforming to the inner surfaces (110) of the closed end (108) of the outer tube (107). The bulbous shape may be a tear-drop shape. The diffuser may be made as a solid part from a material capable of resisting high temperatures, such as nickel-based alloy in one example or it may be hollow to save on material costs. The diffuser (114) may be made from the same material as the heat exchanger (106), and may attach to the inner tube (102) by means of complementary threaded sections (not shown) on the inner tube and inner surfaces of the diffuser (114), or in other embodiments there could be a mechanical coupling (such as one or more fins) between the inner surfaces (110) of the closed end (108) and the bulb (124) portion of the diffuser (114). The diffuser (114) could also be integrally formed with the inner tube (102) in other embodiments.

The inner tube may have a nozzle (126) at its open end (112) that reduces a width of the inner tube (102) so as to accelerate working fluid exiting the open end. In the illustrated embodiment, the diffuser (114) has a central bore (128) into which the inner tube (102) snugly fits, and an integral, projecting inner portion (130) which overhangs the open end (112) to form the nozzle (126). In other embodiments, the nozzle could be a separate part from the diffuser or could be formed by a narrowing of the open end (112) of the inner tube (102).

In this example, the inner tube (102) and hollow tubular chamber (104) are concentric cylindrical tubes, and the diffuser has an annular cross section taken on the axis (123) along the length of the inner tube (102) and is axisymmetric. Different geometries of the inner tube (102), tubular chamber and diffuser may be suited for other applications.

The heat transfer device (100) may be part of a heat transfer assembly, such as the example of the heat transfer assembly (10) of FIG. 1, that includes a plurality of heat transfer devices (100) clustered together with the closed ends (108) of the heat exchanger outer tubes (107) being directed to receive reflected solar radiation so that maximum heating occurs at the closed ends (108). The heat transfer assembly (10) may thus be part of a central receiver of a solar thermal energy system. An inlet chamber (14) and an outlet chamber (16) of the heat transfer assembly (10) may be connected to each other by way of the plurality of heat transfer devices (100) such that the inlet chamber (14) communicates with the inner tubes (102), and the outlet chamber (16) communicates with a space external of the inner tubes (102) and within the hollow tubular chamber (104) of the heat exchanger outer tubes (107).

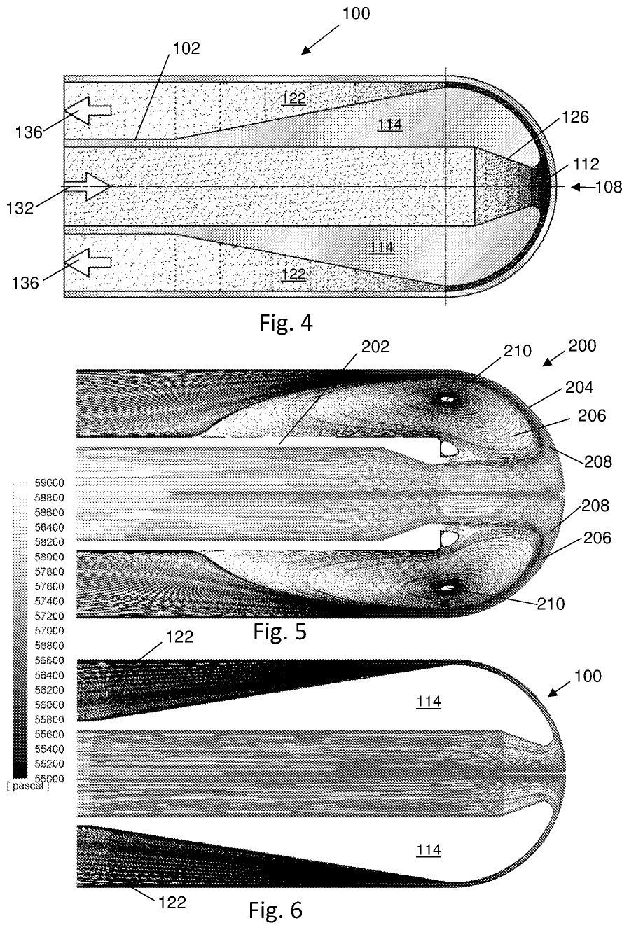

FIG. 4 is a schematic illustration similar to FIG. 3 but showing working fluid dynamic pressure by means of the density of dots, with a high dot density representing high dynamic pressure. The function of the heat transfer device (100) is now described with reference to FIGS. 1 to 4. In use, a working fluid which could be pressurized air but may be any suitable working fluid such as water, steam, carbon dioxide or molten salt, is introduced under pressure into the inlet chamber (14). The working fluid then moves into the inner tube (102) of each heat transfer device (100), as shown by arrow (132), is accelerated at by the nozzle (126) to increase its dynamic pressure and then exits the open end (112) of the inner tube (102). The working fluid then impinges on the inner surfaces (110) of the closed end (108) of the tubular chamber (104). The zone of impingement is an area of maximum working fluid velocity and maximum dynamic pressure. The working fluid is then directed through the flow passageway (118) between the front part (116) of the diffuser (114) and the inner surfaces (110) of the closed end (108).

In this embodiment the flow passageway (118) has a substantially consistent width resulting from the shape of the front part (116) of the diffuser (114) conforming to the shape of the closed end (108), but it is envisaged that the width of the flow passageway could narrow slightly away from the central point of impingement so as to affect a uniform dynamic pressure in the narrow passage way. What is desired is that a high velocity of the working fluid through the narrow flow passageway (118) must be preserved, and therewith a large heat transfer coefficient, which is achieved by putting the front part of the diffuser (114) near the closed end (108). A large heat transfer coefficient is desired because the closed end (108) of the heat exchanger is where the maximum radiation is received and is therefore a zone of maximum heating. It is also advantageous for channel flow to occur in the narrow flow passageway (118), which is where the flow area is constant with respect to an axis perpendicular to the direction of fluid motion. Implementing channel flow allows the velocity, as well as the large surface heat transfer coefficient, to be maintained throughout the region of the narrow flow passageway (118). Turbulent eddies and other phenomena that dissipate mechanical energy are reduced when using this heat transfer device (100) when compared with an impinging jet (200).

After moving through the narrow flow passageway (118), the working fluid undergoes pressure recovery in the diffusion zone (122). Kinetic energy in the working fluid is recovered in the diffusion zone (i.e. dynamic pressure is recovered into static pressure). The working fluid is gradually dispersed into a larger flow area in a way that does not cause substantial eddies and expansion of the working fluid is controlled. The diffusion process is completed when an annular (or, in other embodiments, another outside geometry such as a hexagonal) flow region begins, where the working fluid moves through the space external of the inner tube (102) and within the hollow tubular chamber (104) as shown by arrows (136) to communicate with the outlet chamber (16). The heated working fluid can then be transported from the outlet chamber (16) to a turbine (not shown) for generating electricity. The impingement heat transfer device (100) may therefore transfer heat resulting from concentrated solar radiation to a pressurized air stream at high temperature. A larger rate of heat transfer may be achieved with lower change in total pressure around the entire device than in previous devices.

Simulation Results

FIG. 5 is a Computational Fluid Dynamics (CFD) simulation showing pressure contoured path lines in a reference heat transfer device (200) not according to the invention. FIG. 6 is similar to FIG. 5 and shows total pressure contoured path lines in the heat transfer device (100) of an embodiment of the invention.

The reference heat transfer device (200) may be typical of existing heat transfer devices in which an inner tube (202) carries a pressurized working fluid which impinges on inner hemispherical surfaces of an outer tube (204). As can clearly be seen in FIG. 5, the fluid undergoes rapid expansion in a region (206) immediately adjacent to the impingement region (208). This means that a significant amount of mechanical energy is dissipated in the form of heat in this region. Recirculating, steady state Reynolds Averaged Navier Stokes (RANS) ring vortexes (210) can also be observed. These ring vortexes result in particles of working fluid that have already passed the impingement zone and become heated to circulate back, which decreases the heat transfer efficiency of the device. The RANS ring vortexes also illustrate that significant pressure losses occur in this device.

Turning now to FIG. 6, it can be observed that there are no (or substantially no) RANS ring vortexes due to the presence of the diffuser (114). The high pressure in the impingement zone is maintained, as well as channel flow in this region, and pressure is then gradually recovered in the diffusion zone (122).

These simulation results show a significant improvement in the conserved total pressure of the heat transfer device (100) of FIG. 6 as compared with the heat transfer device (200) of FIG. 5.

Experimental Results

A prototype heat transfer device (300) was made with the physical dimensions (in mm) shown in FIG. 8. This heat transfer device (300) had a throat diameter of 16 mm as shown. A second similar heat transfer device prototype (not shown) was made with a throat diameter of 12 mm.

The two heat transfer devices were compared with two reference nozzle configurations with the same throat diameters (16 mm and 12 mm) but without the diffuser. An experiment was conducted to measure the heat transfer and total pressure loss performance characteristics of the two heat transfer devices in comparison with the two references.

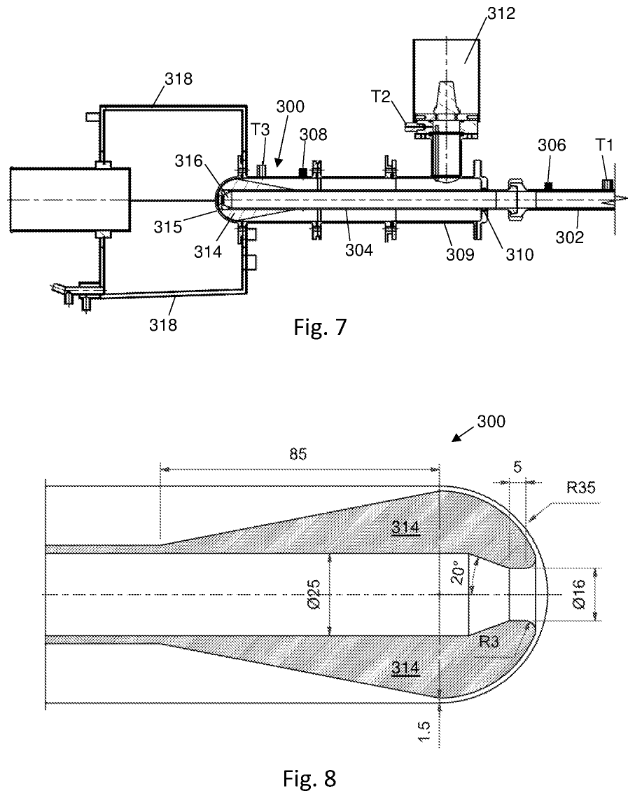

FIG. 7 shows the experimental setup. An air inlet (302) directs pressurized air towards an inner tube (304). The inlet temperature is measured at T1. The differential static pressure is measured between a first pressure meter (306) and a second pressure meter (308). An outlet section (309) surrounds the inner tube (304) and is sealed with an O-ring (310). The outlet section (309) communicates with an exhaust (312). A diffuser (314) as previously described is removably fitted onto a nozzle assembly (316). Using a sensor T3, the temperature stratification around the adverse pressure gradient region of the prototype and references is measured. The exhaust (312) contains a silencer and air exits to the atmosphere. The exhaust (312) also contains a wire gauze to homogenize the air temperature at a final temperature sensor T2. Heat is added by means of steam condensation using a steam bath (318) with the steam condensing on the exterior of the hemisphere (315). The heat transfer rate is determined from the change in air temperature between T1 and an average measurement at T2. To ensure the accuracy of the heat addition measurement, the heat addition through latent heat is also determined by measuring the rate of condensate accumulation. The total pressure loss of the system is measured using a combination of a gauge pressor sensor and numerous differential pressure transducers.

For these relatively low-temperature experiments, a uniform temperature heat addition on the exterior hemispherical surface (315) of 100° C. occurred with an average air inlet temperature of 22° C.

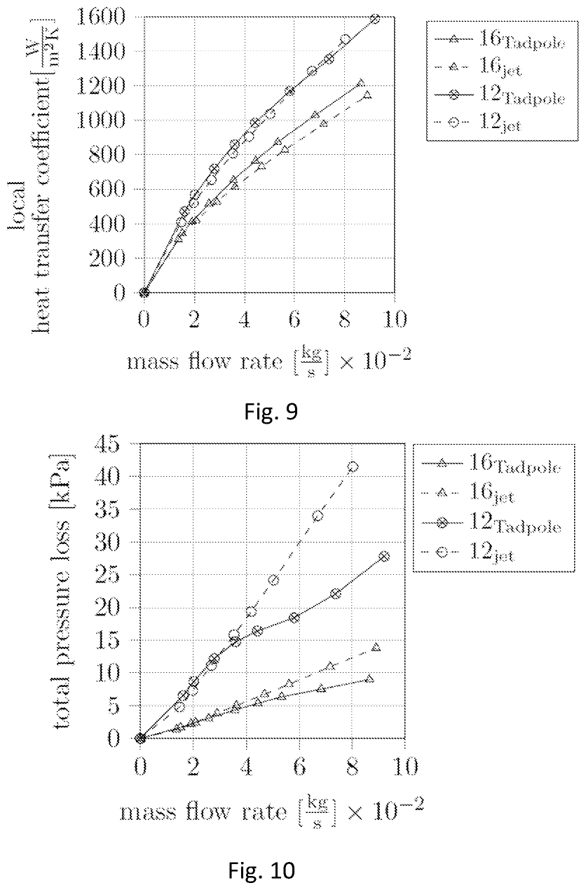

FIG. 9 is a graph showing the heat transfer coefficient as a function of mass flow rate of the two prototypes, referred to as “16_{Tadpole}” for the 16 mm prototype (the word “Tadpole” being reminiscent of the shape of the diffuser) and “12_{Tadpole}” for the 12 mm prototypes, in comparison with the two references, being jet impingement heat transfer devices without diffusers labelled “16_{Jet}” and “12_{Jet}”. It can be seen that the 12 mm prototype has a similar heat transfer coefficient as the 12 mm reference, while the 16 mm prototype exhibits a larger heat transfer coefficient for all mass flow rates.

FIG. 10 is a graph showing the total pressure loss of the two prototypes in comparison with the two references, as a function of mass flow rate. The total pressure loss for the 12 mm prototype is significantly lower for all mass flow rates above 3×10⁻² (kg/s), and the total pressure loss for the 16 mm prototype is lower across all mass flow rates.

The results show that the experimental prototypes generally exhibit improved heat transfer performance with the same or lower loss in total pressure when compared to the reference nozzles, particularly at higher mass flow rates. The heat transfer device was therefore generally demonstrated to improve heat transfer and pressure loss characteristics in the geometry under investigation, namely impingement within a hemispherical dome.

Computational Fluid Dynamic Results

Since the experimental set-up could only be used at relatively low temperatures, compared to temperatures of several hundreds of degrees Celsius in actual concentrating solar energy system receivers, a high temperature computational fluid dynamics (CFD) analysis was done based on the model and validated with the low temperature experimental results. The high temperature CFD analysis was executed with uniform flux heat addition on the exterior hemispherical surface (315) of 450 kW per m² and an air inlet temperature of 413′G:

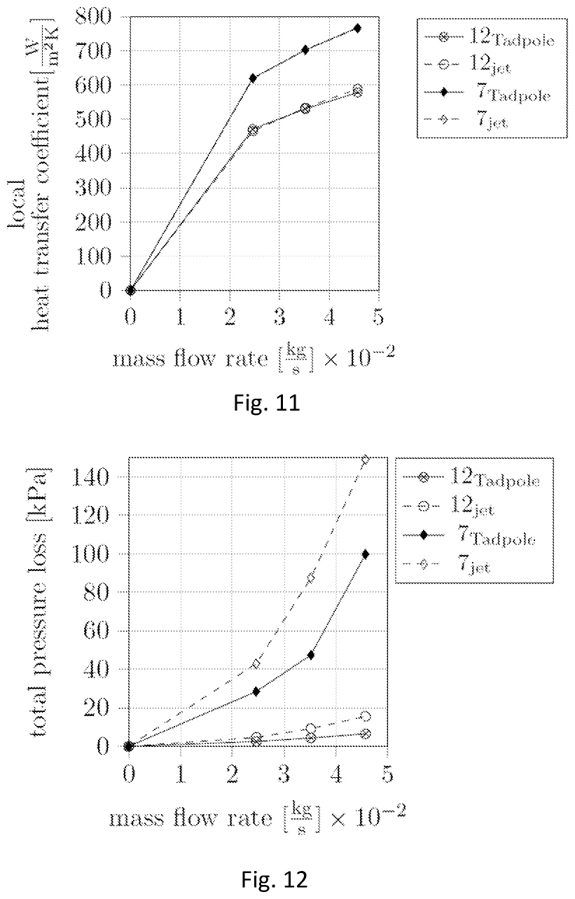

The geometry of the prototypes can be chosen to achieve a favourable combination of heat transfer and pressure loss characteristics. To simplify the comparison between the prototypes and the reference jet impingement devices, the reference dimensions of the CFD-generated prototypes were chosen to exhibit similar heat transfer characteristics as the reference impinging jets, so that total pressure losses can be compared. FIG. 11 shows these overlapping heat transfer characteristics between a 7 mm throat diameter prototype (7_{Tadpole}) and a 7 mm throat diameter reference (7_{Jet}), and between a 12 mm throat diameter prototype (12_{Tadpole}) and a 12 mm throat diameter reference (12_{Jet}). As can be seen from the overlapping lines, the heat transfer characteristics of the two prototypes and two references are almost identical in this high temperature CFD analysis.

FIG. 12 shows the resultant total pressure loss characteristics of the two prototypes (7_{Tadpole} and 12_{Tadpole}) as well as the two references (7_{Jet} and 12_{Jet}). As can clearly be seen, both prototypes have significantly lower pressure loss across all mass flow rates than the corresponding reference of the same throat diameter. The total pressure loss reduction for the 12_{Tadpole} is on average 52.4% and the reduction is on average 37.5% for the 7_{Tadpole}.

The heat transfer device may be used in many applications in which a large heat flux is concentrated onto a small surface area and the fluid that is being heated (or cooled) has a low capacity for heat transfer, such as air. The device is useful because the required amount of energy to move the working fluid through the device is low relative to existing devices (i.e. the loss in total pressure is low) while the rate of heat transfer is improved.

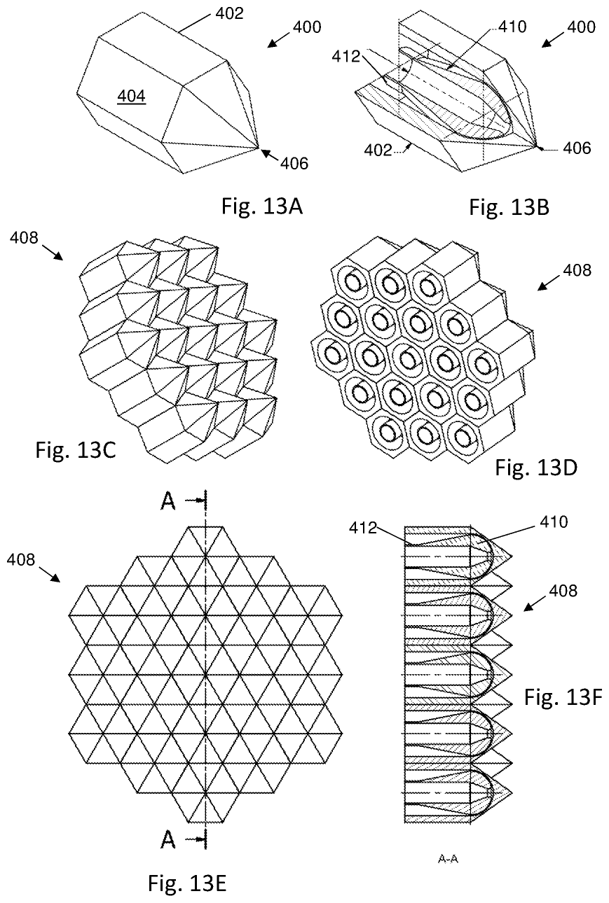

FIGS. 13A to 13F illustrate an alternative embodiment of a heat transfer device (400). In this embodiment, a heat exchanger (402) has a hexagonal prismatic body (404) and a closed end (406) with pyramidally shaped outer surfaces. A plurality of identical heat transfer devices (400) can be clustered together in tessellated fashion to form a heat transfer assembly (408), as illustrated in FIGS. 13C to 13E. The heat transfer assembly (408) can form part of a central receiver of a solar thermal energy system as previously described. In the embodiment of FIGS. 13A to 13F, a diffuser (410) is provided around a central tube (412) in a similar manner to previously described, with an operatively front part of the diffuser conforming to the shape of inner surfaces of the closed end (406).

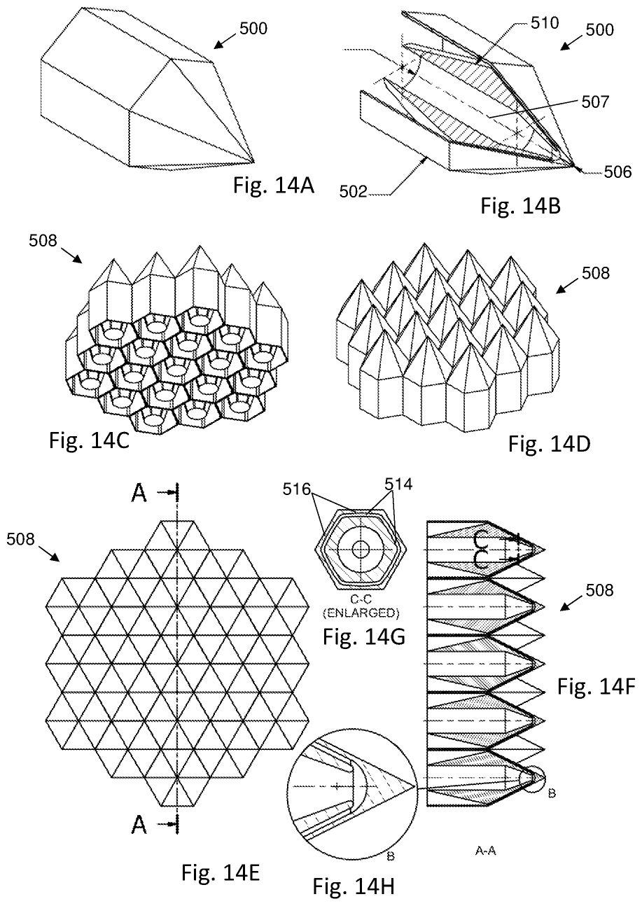

FIGS. 14A to 14H illustrate a further alternative embodiment of a heat transfer device (500). In this embodiment, a closed end (506) of a hexagonal prismatic body (504) has a somewhat steeper pyramidal shape. As in FIG. 13, the heat transfer devices (500) can be tessellated to form a heat transfer assembly (508). However, as shown in the “C-C enlarged” cross-section of FIG. 14G, in this embodiment a diffuser (510) is not rotationally symmetric about its axis (507), but has a number of distinct faces (514) in its operatively front part so as to conform to similarly shaped inwardly sloping inner surfaces (516).

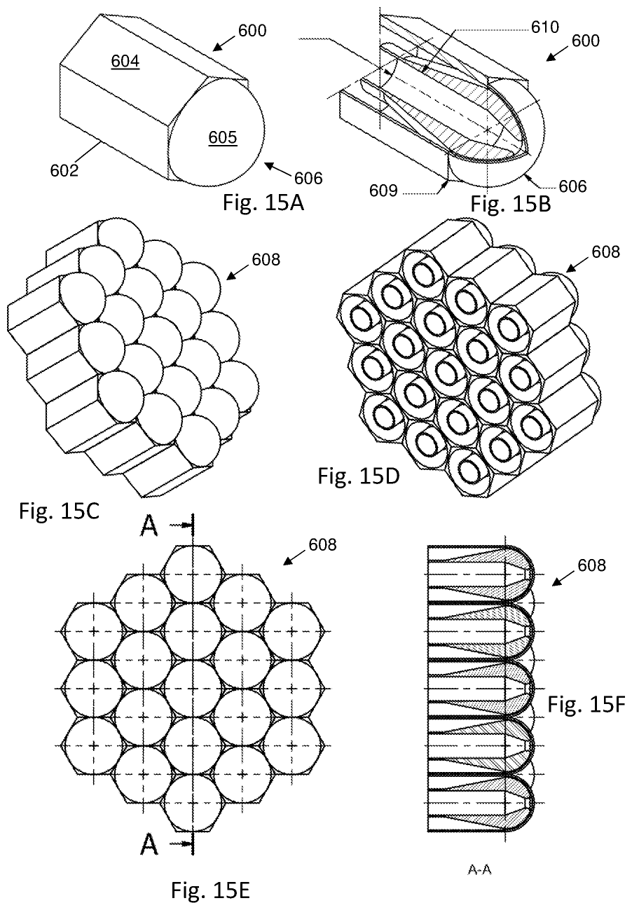

FIGS. 15A to 15F illustrate a yet further alternative embodiment of a heat transfer device (600). This implementation uses the same hexagonal prismatic body (604) for the heat exchanger (602) as shown in FIG. 13, but includes a hemispherical closed end (606) forming a dome (605) with corresponding hemispherical inner surfaces. A shoulder (609) is formed at the area where the body (604) meets the dome (605). Multiple heat transfer devices (600) can be tessellated in a honeycomb fashion to form a heat transfer assembly (608) as before. Having a hemispherical dome (605) with a hemispherical inner surface may be advantageous in that it may be more robust against temperature changes as the heat transfer assembly is cycled through differing levels of solar radiation. Flat surfaces may suffer from material cycle fatigue when temperature and pressure are cycled (e.g. daily, accordingly to solar flux). It may also have lower radiation losses than the pyramidal implementations, since the heat transfer devices (600) may be more effective at absorbing heat. The tessellated structure enables scaling according to the desired thermal rating.

The invention is not limited to use in central solar receiver applications, and could be used in applications where the working fluid is cooled or heated. Many other geometries of heat transfer devices are possible which fall within the scope of the invention.

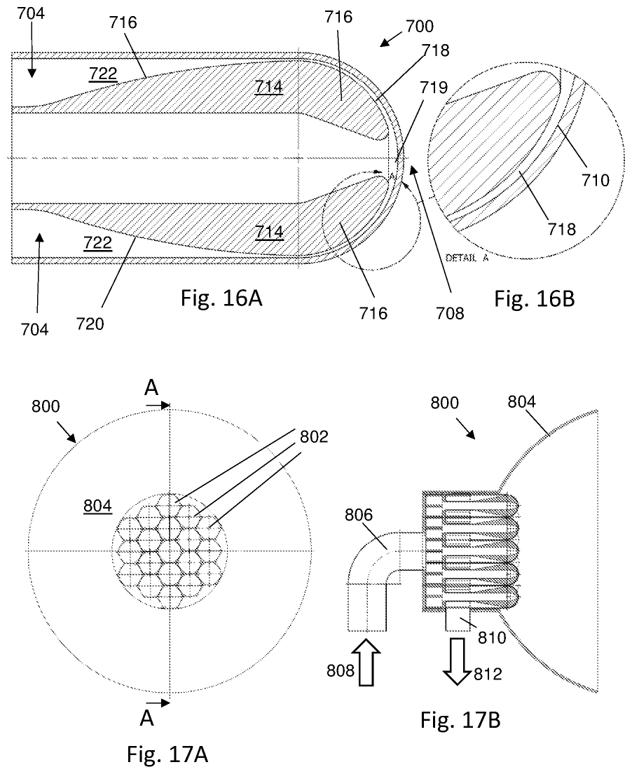

FIGS. 16A and 16B show cross sectional views of a still further alternative embodiment of a heat transfer device (700). This embodiment differs from the embodiment of FIGS. 2 and 3 in two important ways. Firstly, the flow passageway (718) in this embodiment does not have a consistent width and therefore the front part (716) of the diffuser (714) of this embodiment does not conform exactly to the inner surfaces (710) of the closed end (708) of the hollow tubular chamber (704). Instead, the front part (716) is shaped so that the flow passageway (718) narrows away from a central point (719) of impingement. Because the total cross-sectional area of the flow passageway (718) increases away from the central point of impingement (719), narrowing the flow passageway (718) as illustrated may maintain the dynamic pressure within the zone of maximum heating at the closed end (708). Secondly, the back part (720) of the diffuser (714) slopes or transitions on a curve instead of a straight line. This may improve the pressure recovery characteristics in the diffusion zone (722) of this embodiment.

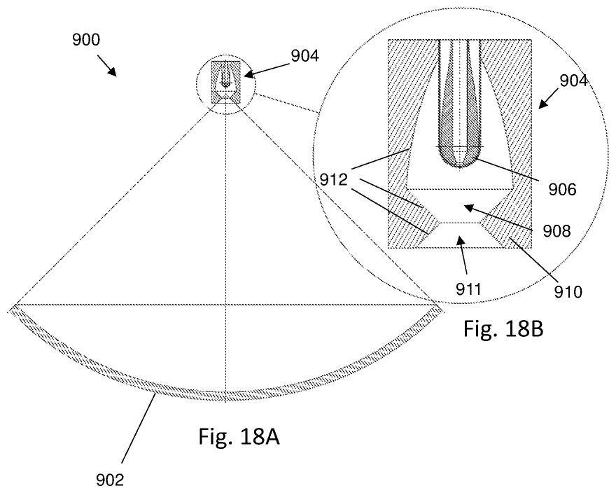

FIGS. 17A and 17B show an alternative heat transfer assembly (800) which forms part of a central receiver of a solar thermal energy system. The heat transfer assembly (800) includes a plurality of heat transfer devices (802) which are arranged in a tessellated manner. In this illustration, the heat transfer devices (802) have a hexagonal prismatic body with a hemispherical closed end forming a dome, according to the embodiment of FIGS. 15A to 15E, but they could alternatively be according to any one of the other described embodiments, for example those of FIGS. 13A to 13F or 14A to 14H. The heat transfer assembly (800) includes a dish structure (804) which surrounds the heat transfer devices (802) and acts as a secondary reflector. The function of the dish structure (804) is to reflect incoming radiation from a field of heliostats towards the heat transfer devices (802) that would otherwise have been lost as spillage. The dish structure (804) may therefore have a parabolic or other appropriate shape.

A working fluid (such as pressurized air) enters the heat transfer assembly (800) by means of an inlet chamber or manifold (806), as shown by arrow 808, and is distributed to each heat transfer device (802). The air is heated within each heat transfer device (802) by concentrated solar radiation and the air then exits through an outlet chamber or manifold (810) as shown by arrow 812. The inlet and outlet manifolds (806, 810) operate at a relatively low flow velocity compared to the flow velocity in each heat transfer device (802), to facilitate low pressure losses. As previously described, the diffusers of each heat transfer device (802) accelerate the flow in the narrow flow region to enable effective heat transfer while subsequently recovering the dynamic pressure in the diffusion zone by efficiently decelerating the working fluid.

FIG. 18A shows a further alternative heat transfer assembly (900) which forms part of a central solar receiver of a solar thermal energy system. The heat transfer assembly (900) includes a parabolic dish (902) spaced apart from a receiver (904). The parabolic dish reflects sunlight onto the receiver (904). In this illustration, the receiver (904) includes a single impingement heat transfer device (906), shown most clearly in FIG. 18B, which may be according to any of the embodiments previously described (including where the diffuser section is curved as illustrated), mounted within a cavity (908) formed by a receiver body (910). The cavity (908) in the receiver body (910) is shaped with differently angled internal walls (912) so that incoming solar radiation reflected by the parabolic dish (902) enters through an aperture (911) in the receiver body (910) and is substantially trapped and is reflected and re-reflected within the cavity (908) to be directed onto the single impingement heat transfer device (906). This heat transfer assembly (900) may be coupled to a gas turbine, where the impingement heat transfer device (906) is physically larger in this embodiment than in the other illustrated heat transfer assemblies where multiple heat transfer devices are used.

The foregoing description has been presented for the purpose of illustration; it is not intended to be exhaustive or to limit the invention to the precise forms disclosed. Persons skilled in the relevant art can appreciate that many modifications and variations are possible in light of the above disclosure.

The language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

Finally, throughout the specification and accompanying claims, unless the context requires otherwise, the word ‘comprise’ or variations such as ‘comprises’ or ‘comprising’ will be understood to imply the inclusion of a stated integer or group of integers but not the exclusion of any other integer or group of integers.

1. A heat transfer device comprising an inner tube mounted within a hollow tubular chamber of a heat exchanger, the hollow tubular chamber having a closed end that has concave or inwardly sloping inner surfaces and the inner tube having an open end that terminates short of the closed end of the tubular chamber, wherein a diffuser is provided around a section of the inner tube adjacent its open end, the diffuser being shaped such that an operatively front part of the diffuser substantially conforms to a shape of the inner surfaces of the closed end of the hollow tubular chamber so as to form a narrow flow passageway between the diffuser and the inner surfaces at the closed end, and an operatively back part of the diffuser slopes or transitions towards the inner tube and away from its open end to form a diffusion zone in the hollow tubular chamber, wherein a working fluid moves through the inner tube to exit its open end, impinges on the closed end of the tubular chamber, is directed through the narrow flow passageway and undergoes pressure recovery in the diffusion zone.

2. The heat transfer device as claimed in claim 1 in which diffuser has a bulbous shape in cross section along an axis of the inner tube, with a bulb portion of the bulbous shape conforming to the inner surfaces of the closed end of the heat exchanger's tubular chamber.

3. The heat transfer device as claimed in claim 1 in which the closed end of the tubular chamber is concave.

4. The heat transfer device as claimed in claim 3 in which the closed end of the tubular chamber is hemispherical.

5. The heat transfer device as claimed in claim 1 in which the heat exchanger is an outer tube with a closed end.

6. The heat transfer device as claimed in claim 1 in which the inner tube has a nozzle at its open end that reduces a width of the inner tube to accelerate the working fluid exiting the open end.

7. The heat transfer device as claimed in claim 6 in which the nozzle is integral with the diffuser and is formed by a projecting inner portion of the diffuser.

8. The heat transfer device as claimed in claim 1 in which the diffuser is made from a nickel-based alloy material that is capable of resisting high temperatures.

9. The heat transfer device as claimed in claim 1 in which the diffuser is made as a solid part and includes an attachment formation by which it can be attached to the inner tube or to inner surfaces of the closed end of the hollow tubular chamber.

10. The heat transfer device as claimed in claim 1 in which the working fluid is pressurized and is chosen from air, water, steam, carbon dioxide and molten salt.

11. The heat transfer device as claimed in claim 1 in which the heat transfer device is an impingement heat transfer device and the working fluid is air.

12. A heat transfer assembly comprising at least one heat transfer device as claimed in claim 1 arranged with the closed ends of the or each heat transfer device directed to receive reflected solar radiation so that maximum heating occurs at the closed ends.

13. A heat transfer assembly as claimed in claim 12 in which a plurality of heat transfer devices are clustered together in a tessellated manner.

14. A heat transfer assembly as claimed in claim 13 which includes an inlet chamber and an outlet chamber connected to each other by way of the plurality of heat transfer devices such that the inlet chamber communicates with the inner tubes and the outlet chamber communicates with a space external of the inner tubes and within the hollow tubular chambers of the heat exchangers.

15. A heat transfer assembly as claimed in claim 12 which includes a dish structure surrounding the plurality of heat transfer devices for reflecting sunlight focused on the dish structure onto the heat transfer devices.

16. A heat transfer assembly as claimed in claim 12 in which one heat transfer device is mounted within a cavity formed by a receiver body, the receiver body being shaped with differently angled internal walls so that incoming solar radiation enters through an aperture in the receiver body, is substantially trapped and is reflected within the cavity to be directed onto the heat transfer device.

17. A heat transfer assembly as claimed in claim 16 in which the heat transfer assembly includes a dish structure spaced apart from the receiver body for reflecting sunlight focused on the dish structure into the aperture.
